(19) United States
(12) Patent Application Publication
(10) Pub. No.: US 2011/0175540 A1
(43) Pub. Date: Jul. 21, 2011

(54) OVERLOAD PROTECTION DEVICE FOR LED LUMINARY

(76) Inventors: Han-Peng Hsu, Taichung City (TW); Pei-Yeh Hsieh, Taichung City (TW); Wei-Chia Hsu, Taichung City (TW); Wei-Shin Hsu, Taichung City (TW)

(21) Appl. No.: 12/689,679

(22) Filed: Jan. 19, 2010

(51) Int. Cl. H05B 41/36

(52) U.S. Cl. 315/291; 315/307

(57) ABSTRACT

An overload protection device for LED luminary includes a light bulb connected in front of a circuit that has a single or a group of LED luminaries thereon. The light bulb forms an energy consumption device. The energy consumption device can change the consumption value automatically to protect the LED luminary.

### BACKGROUND OF THE INVENTION

1. Field of the Invention

The present invention relates to a circuit protection device, and more particular to an overload protection device for LED luminary, which has an energy consumption device, can change the energy consumption value automatically.

2. Description of the Related Art

A range of a withstand voltage of LED luminary is narrow and usually is between 0.1-0.9 volt. For example, the range of the withstand voltage for a red light LED is about 2.2V˜2.6V and a white light LED is about 3.0V˜3.5V. And the LED uses little of electric current and usually is between 0.01-0.09 milliampere. In conclusion, the LED luminary is very friability. So, the circuit that has LED luminary on it needs to have a rectification circuit or a stabilizer circuit thereon or uses a battery or a capacitance as a buffer. In prior art, all these protection devices increase cost and the size of the circuit.

If the input power source is not a stable power source. For example, a generator is driven by a bicycle or hands. The voltage and the electric current of the generator changes with the rotation speed of the generator. For this reason, the protection circuit becomes more complication and increases cost and space. Making the circuit small and low cost are challenges for those manufacturers who want to use LED luminary on a bicycle or outdoor. However, the circuit, which uses on a mobile phone, camera, notebook, television or the like, may have a better choice if there is a small and low cost overload protection device for LED luminary.

### SUMMARY OF THE INVENTION

The primary object of the present invention is to provide an overload protection device for LED luminary, which has the advantages of simple structures, low cost and small size.

To achieve this and other objects of the present invention, an overload protection device for LED luminary comprises a light bulb connecting with a circuit which connects a LED luminary in series to form an energy consumption device, which can change the energy consumption value automatically. The light bulb has a filament as a resister to generate light and heat and has a range of a withstand voltage. In design, a whole voltage that is the sum of the circuit load voltage and a maximum withstand voltage of the light bulb is large than a maximum voltage that input from an outside power source. Thereby, the larger the withstand voltage of the light bulb, the better of the protection effect is.

### BRIEF DESCRIPTION OF THE DRAWINGS

FIG. 1 is a circuit diagram of a first embodiment of the present invention;

FIG. 2 is a circuit diagram of a second embodiment of the present invention;

FIG. 3 is a circuit diagram of a third embodiment of the present invention;

FIG. 4 is a circuit diagram of a fourth embodiment of the present invention.

### DETAILED DESCRIPTION OF THE INVENTION

There are four preferred embodiments in the present invention of this application hereinafter.

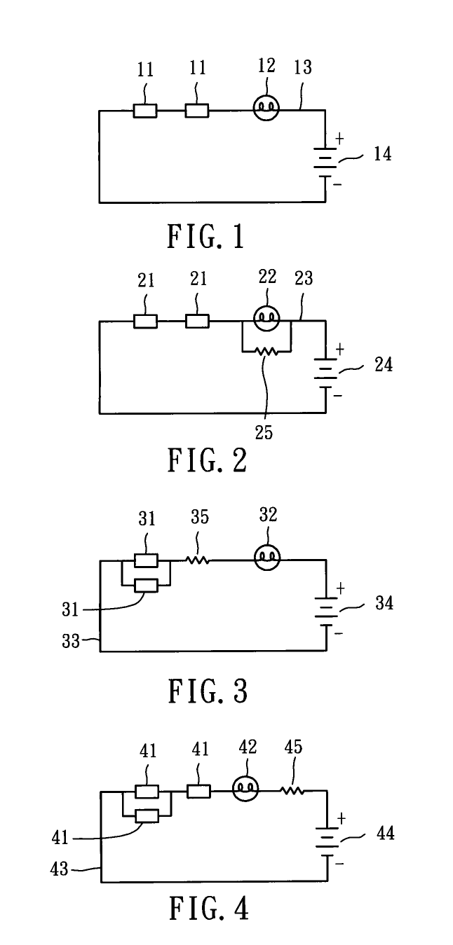

As shown in FIG. 1, an overload protection device for LED luminary of the first embodiment of the present invention comprises two LED luminaries (11) and a tiny light bulb (12) with tungsten filaments connected in series by an electric wire (13) and connected to an outside power source (14).

A nominal voltage of each LED luminary (11) is 3V, a range of a withstand voltage of the light bulb (12) is 6V˜32V, and an input voltage of the outside power source (14) is 12V. The LED luminaries (11) only use a little electric current which is about 0.08 mA. Thereby, the electric current that passed through the light bulb (12) still can make the LED luminary (11) to generate light. After a period of use, the efficiency of the LED luminary (11) decreases and causes the withstand voltage of the LED luminary (11) decreased. For example, the voltage decreases to about 2.8V and the whole voltage in the series connection electric wire (13) of these two LED luminaries (11) change from 6V to 5.6V. In the meanwhile, the voltage of the light bulb (12) rises from 6V to 6.4V automatically and the total voltage is invariable as 12V. The voltage of the light bulb (12) rises up and causes the illumination of the light bulb (12) increased slightly. In present invention, the excess energy is consumed by the generation of light and heat of the light bulb (12). Therefore, the LED luminary (11) can be protected and always keep in the best efficiency condition.

In prior art, people usually take a very conservative method to deal with the efficiency decrease problem. For example, a maximum withstand voltage of a LED luminary is 3.3V in the beginning. But the maximum withstand voltage may become 3.2V˜3.1V after the efficiency decreased. For the safe reason, the nominal voltage usually is designed as 3V. So, the LED luminary can only provide about 80 or 90 percent of illumination. It is pity that LED luminary can not provide 100 percent of illumination. The present invention can adjust the efficiency of aforesaid situation automatically. For example, as the first embodiment of the present invention, if the withstand voltage of these two LED luminaries (11) reach 3.3V (6.6V in series connection), the consumption of current increases slightly. So, the LED luminary can provide 100 percent of illumination and the brightness is higher than 80 or 90 percent of illumination. However, the lower voltage, which changes from 6V to 5.4V, causes the light bulb (12) to provide less brightness and heat. The voltage of the light bulb (12) becomes 5.8V when the efficiency of these two LED luminaries (11) changes from 3.3V to 3.1V (6.2V in series connection). The light bulb (12) is brighter than aforesaid situation and the LED luminary (11) still provide 100 percent performance.

When the voltage or the current inputting from outside power source (14) changes, for example, the outside power source (14) is generated by a generator that is driven by a wheel of a bicycle. The voltage and the electric current of the outside power source (14) will be changed depends on the rotation speed of the wheel. For example, the voltage may change from 12 V to 24 V and the electric current may change from 0.5 mA to 1 mA or even higher. At this moment, the light bulb (12) consumes the excess voltage and excess electric current. The LED luminary (11) has sufficient protection and sufficient power. The only result is that the light bulb (12) generates more brightness and heat.

The present invention uses a traditional tungsten filaments light bulb (12) as a changeable energy consumption device to protect the LED luminary (11). The LED luminary (11) is provided with sufficient voltage and electric current anytime. The LED luminary (11) provides 100 percent of efficiency anytime and reaches the best illumination effect. The tungsten filaments light bulb (12) consumes the excess energy (voltage and electric current). It is not necessary to use a commutation circuit or a stabilizer circuit. The present invention has the advantage of simple structures, low cost and small size and occupies less space. In order to have the best effect, the light bulb of the present invention preferably is a customization light bulb for minimizing the size and maximizing the range of the withstand voltage. Otherwise, a traditional light bulb like a fuse light, which is used in a car, can be used.

As shown in FIG. 2, an overload protection device of a second embodiment of the present invention comprises two LED luminaries (21) and a tiny light bulb (22) connect in series by an electric wire (23) and connect to an outside power source (24). The aforesaid structures are similar as the first embodiment. The different is that the device further comprises a resister (25) parallel connecting with the light bulb (22). The total resistance value is decreased because of the light bulb (22) that parallel connected with the resister (25). But, the electric current that goes to the LED luminary (21) rises up. This design can surely provides sufficient electric current to the LED luminary (21).

Referring to FIG. 3, an overload protection device of a third embodiment of the present invention comprises two LED luminaries (31) that connect in parallel, a light bulb (32), an electric wire (33), an outside power source (34) and a resister (35). The resister (35) is connected between the light bulb (32) and the LED luminaries (31).

Referring to FIG. 4, an overload protection device of a fourth embodiment of the present invention comprises three LED luminaries (41). Two of these three LED luminaries (41) connect in parallel first and then connect with the third LED luminary (41) in series. A light bulb (42) and a resister (45) connect with these LED luminaries (41) in series by an electric wire (43) and connect to an outside power source (44).

Those aforesaid embodiments of the present invention are only illustrations. They are not the limitation of the present invention. In fact, the electric circuit can further connects with other electrical elements. However, the main spirit of the present invention is using an energy consumption device that can changes the consumption value automatically. The energy consumption device, which places in front of the LED luminary, connects with the LED luminary (single or a group) in series. The energy consumption device provides sufficient voltage and electric current to the LED luminary and makes the LED luminary provided 100 percent illumination and best efficiency. The energy consumption device consumes excess energy (voltage and electric current) of the circuit for protecting the LED luminary.

In practical operation, the LED luminary places on a circuit board. The light bulb places on a side or a backside of the circuit board or places outside of the circuit board and hides in a shell of an electrical device. The light bulb is used for to consume energy. The light bulb consumes little energy in the whole circuit device. However, for an outside power source which is a small generator, the light bulb further consumes the excess energy provided by the small generator.

What is claimed is:

1. An overload protection device for LED luminary, comprising a light bulb connecting with a circuit which connects a LED luminary in series to form an energy consumption device; said light bulb having a filament as a resister and generating light and heat, and said light bulb having a range of a withstand voltage.

2. The overload protection device as claimed in claim 1, wherein a voltage, which is the sum of the load voltage of the circuit and a maximum withstand voltage of the light bulb, is larger than a maximum voltage that input from an outside power source.

3. The overload protection device as claimed in claim 1, wherein the light bulb is a tiny tungsten filament light bulb.
